(19) United States
(12) Patent Application Publication
(10) Pub. No.: US 2008/0060903 A1
(43) Pub. Date: Mar. 13, 2008

(54) Automatically and continuously adjustable centrifugal clutch

(75) Inventors: Norman Lian, Taipei City (TW); Chun Yi Wu, Jhunan Township (TW)

Correspondence Address: RABIN & Berdo, PC, 1101 14TH STREET, NW, SUITE 500, WASHINGTON, DC, 20005, US

(73) Assignees: Chun Yi WU; Pei Hsuan WU

(21) Appl. No.: 11/519,226

(22) Filed: Sep. 12, 2006

(51) Int. Cl. F16D 43/18; F16D 43/24

(52) U.S. Cl. 192/105 CD; 192/103 C

(57) ABSTRACT

An automatically and continuously adjustable centrifugal clutch has a base plate used to receive a power source; at least one centrifugal weight assembled to the base plate; at least one angular acceleration response assembly connected to the at least one centrifugal weight; and at least one returning element having two ends separately connected to one centrifugal weight and one angular acceleration response assembly. With these arrangements, a relatively high engine revolving speed at clutch engagement may be obtained by an instantaneously quickly increased acceleration rate at starting, so that a mechanism may have a large starting torque and good accelerating ability; and a relatively low engine revolving speed at clutch engagement may also be obtained by slow acceleration at starting to enable smooth starting at reduced fuel consumption.

### FIELD OF THE INVENTION

The present invention relates to a centrifugal clutch for transmitting power, and more particularly to a centrifugal clutch in which centrifugal weights cooperate with one or more angular acceleration response assemblies, so that clutch engagement at different engine revolving speeds may be obtained simply through control of the throttle opening. That is, the clutch engagement may be achieved either at an instantaneously quickly increased acceleration to allow a high torque and good accelerating ability, or a slowly increased acceleration to allow smooth take-off and reduced fuel consumption.

### BACKGROUND OF THE INVENTION

The currently available continuous variable transmission (CVT) for a vehicle generally includes a front pulley, a rear clutch assembly pulley, and a V-belt. The rear clutch assembly pulley includes a centrifugal clutch. Under a centrifugal effect, a wear pad of a centrifugal weight on the clutch is thrown outward to engage with a driven unit and thereby to rotate the driven unit, which further drives a rear wheel to rotate via a gear set, so that the vehicle can move forward.

In a conventional centrifugal clutch, its engaging rev is already a fixed design value, so its initial acceleration (torque) is fixed too.

When it is desired for the vehicle to be more powerful at take-off, it is necessary to disassemble the clutch and replace a clutch spring thereof with one that provides an increased pulling force, or to change the weight of a centrifugal weight of the clutch. In either case, it is very time-consuming to disassemble and replace the clutch springs of the clutch assembly.

In European Patent EP 1310695A, it is taught to increase the tensile strength of a clutch spring by manually changing a connection point of the clutch spring, so as to change the rotation speed for clutch engagement. To manually adjust the clutch spring as taught by EP 1310695A, it is still necessary to remove an outer cover of a CVT (continuous variable transmission). This is obviously inconvenient for a user to do so. Meanwhile, it is still impossible to achieve automatic adjustment of the conventional centrifugal clutch for driving a vehicle to move at different initial acceleration.

Moreover, when the tensile strength of the clutch spring is adjusted higher to obtain a clutch engagement at a higher engine revolving speed and for the vehicle to have a big torque at starting, the fuel consumption of the vehicle increases at the same time. And, when the user does not want to start the vehicle at a high engine revolving speed, he or she has to change the clutch spring again to have a spring of lower tensile strength. In brief, it is impossible for a user to have clutch engagement at different engine revolving speeds as desired at any time. The vehicle can only be moved forward at a fixed high engine revolving speed to consume high amount of fuel. Therefore, with the conventional centrifugal clutch design, it is impossible for a vehicle to meet the requirements of good accelerating ability and economical driving at reduced fuel consumption at the same time. It is therefore desirable to develop an improved automatically and continuously adjustable centrifugal clutch that allows easy adjustment of the clutch engagement at different engine revolving speeds.

### SUMMARY OF THE INVENTION

A primary object of the present invention is to provide an automatically and continuously adjustable centrifugal clutch, wherein an angular acceleration response assembly senses a big change in rotating inertia when the throttle is instantaneously fully opened and the angular acceleration of the engine is increased instantaneously, and the angular acceleration response assembly will proceed a displacement in the opposite direction of the rotation of centrifugal clutch such that the returning force of the returning element become higher; the rotation speed of engine or centrifugal clutch has to be increased continuously to a level that the centrifugal force of the centrifugal weight is stronger enough to overcome the returning force of the returning element and centrifugally moving outward to engage with the driven unit, allowing the vehicle to have big torque and good initial acceleration at take-off.

Another object of the present invention is to provide an automatically and continuously adjustable centrifugal clutch, in which an angular acceleration response assembly senses a minor change in rotating inertia and does not move in a reverse direction when the throttle of vehicle is slowly accelerated at starting; the returning force of the returning element remaining unchanged (i.e., the original designed value), so that a centrifugal weight of the centrifugal clutch can engage with a driven unit at a low engine revolving speed (i.e., the original designed value), allowing the vehicle to start smoothly at normal fuel consumption.

To achieve the above and other objects, the automatically and continuously adjustable centrifugal clutch according to a first preferred embodiment of the present invention includes:

a base plate used to receive a power source;
at least one centrifugal weight assembled to the base plate;
at least one angular acceleration response assembly connected to the centrifugal weight; and
at least one returning element having two ends separately connected to one centrifugal weight and one angular acceleration response assembly.

Whereby when the power source is started to allow an instantaneously quickly increased acceleration, the base plate is brought to instantaneously circularly accelerate and the at least one angular acceleration response assembly is subjected to a sudden big change in rotating inertia and the angular acceleration response assembly will proceed a displacement in the opposite direction of the rotation direction of centrifugal clutch such that the returning force of the returning element become higher, that means the centrifugal weight is pulled inward more tighter and the original designed centrifugal force of centrifugal weight is not high enough to overcome the returning force of the tensioned returning element; so the rotation speed of the base plate or centrifugal weight has to be increased continuously to a level that the centrifugal force of the centrifugal weight is stronger enough to overcome the higher returning force of the returning element and the centrifugal weight can be moved centrifugally outwardly to thereby engage with and transmit power to a driven unit, allowing a clutch engagement at a high engine revolving speed.

In a vehicle or a mechanism using the automatically and continuously adjustable centrifugal clutch of the present invention, when the engine is started and instantaneously accelerated (i.e. the throttle of a vehicle is fully opened suddenly and instantaneously) and the rotation speed of clutch is instantaneously increased, the angular acceleration response assembly of the present invention is subjected to a big change in rotating inertia and moves in a reverse direction to tension the returning element and pull the centrifugal weight more tightly inwardly. At this point, the original designed centrifugal force of the centrifugal weight is not able to overcome the pull of the more tensioned returning element due to insufficient engine revolving speed. However, when the rotating speed of the base plate or centrifugal weight is continuously increased to let the centrifugal weights produce a higher centrifugal force sufficient to overcome the pull force of the more tensioned returning element, the centrifugal weight finally centrifugally moves outward to frictionally engage with and drive the driven unit to move at a high acceleration speed. When the centrifugal clutch of the present invention engages with the driven unit at the relatively high engine revolving speed, the vehicle or the mechanism may have a large starting or transmitting torque to enable good accelerating ability. On the other hand, when the engine is slowly accelerated (i.e. the throttle is actuated slowly), the engine output is stable and small and there is almost no any change in the rotating inertia, and therefore, the angular acceleration response assembly does not move reversely to pull the retuning element, the returning force of the retuning element remains the same as the original designed value and allowing the centrifugal weight to centrifugally move outward and engage with the driven unit at a low engine revolving speed (i.e., the original design value). In this case, the vehicle or the mechanism may be started smoothly.

With the present invention, a user may suddenly and instantaneously actuate the throttle fully opened at starting when a high initial acceleration or transmission torque is desired. And, when it is not necessary to quickly accelerate at starting, the user may slowly actuate the throttle of the vehicle or accelerate the mechanism smoothly.

In either case, the centrifugal clutch of the present invention can be automatically and continuously adjusted by throttle opening to get different engagement with the driven unit to have different acceleration rates. With this design, the vehicle or the mechanism may be differently accelerated at starting to meet the requirements of high acceleration performance or smoothly economical driving with normal fuel consumption.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of an automatically and continuously adjustable centrifugal clutch according to a preferred embodiment of the present invention;

FIG. 2 is a partially exploded perspective view of FIG. 1 with a cover plate of the centrifugal clutch separated from other parts;

FIG. 3 is another partially exploded perspective view of FIG. 1 showing most major parts of the centrifugal clutch of the present invention;

FIG. 4 is a top view of the centrifugal clutch of FIG. 1 with a cover plate removed therefrom;

FIGS. 5 and 6 are fragmentary top views showing the movements of the automatically and continuously adjustable centrifugal clutch of the present invention;

FIG. 7 is an exploded perspective view of an automatically and continuously adjustable centrifugal clutch according to another embodiment of the present invention; and

FIG. 8 is an assembled view of FIG. 7.

### DETAILED DESCRIPTION OF THE PREFERRED EMBODIMENTS

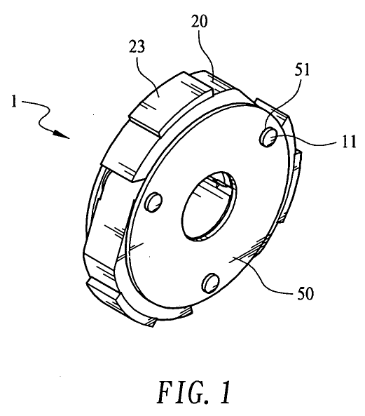

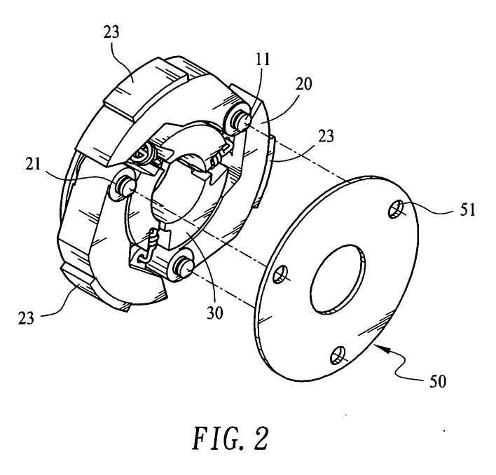

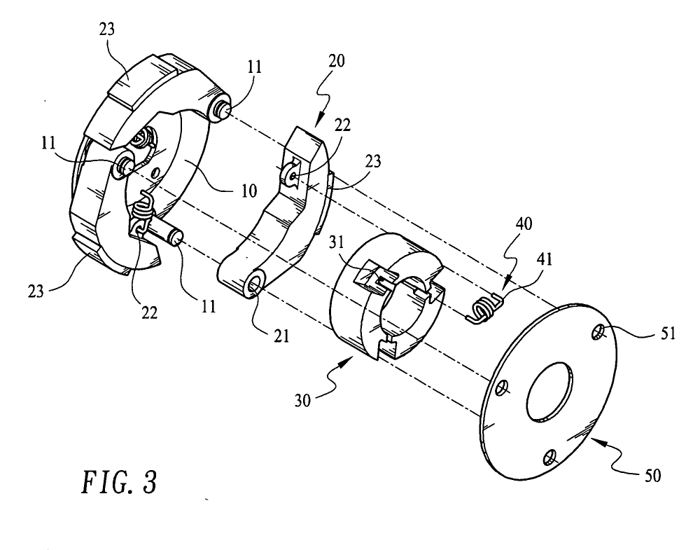

Please refer to FIGS. 1 to 3 that are assembled and exploded perspective views of an automatically and continuously adjustable centrifugal clutch 1 according to a first preferred embodiment of the present invention. For the purpose of conciseness, the present invention is also briefly referred to as “the centrifugal clutch 1” herein. As can be seen from FIG. 3, the centrifugal clutch 1 includes a base plate 10, on which at least one locating section 11 is provided; at least one centrifugal weight 20, which is provided at a first end with a connecting section 21 for engaging with the locating section 11 on the base plate 10, at an inner side of a second end opposite to the first end with an associating section 22, and at an outer surface with a driving face 23; at least one angular acceleration response assembly 30, on which at least one catch section 31 is provided corresponding to the associating section 22 of the centrifugal weight 20; and at least one returning element 40 having two ends 41 separately connected to the associating section 22 of the centrifugal weight 20 and the catch section 31 of the angular acceleration response assembly 30.

In the first illustrated preferred embodiment of the present invention, there are three locating sections 11, three centrifugal weights 20, one angular acceleration response assembly 30, three catch sections 31 on the angular acceleration response assembly 30, and three returning elements 40; and the locating section 11 is a pivot shaft, the associating section 22 is an insertion hole, the driving face 23 is a wear pad, and the returning element 40 is a spring.

In a first preferred embodiment, the angular acceleration response assembly 30 is surrounded by a plurality of centrifugal weight 20, and is an annular member defining a round bore.

In the first illustrated preferred embodiment of the present invention, the base plate 10 is associated with a cover plate 50, which is provided with at least one through hole 51 corresponding to the at least one locating section 11 of the base plate 10.

The centrifugal clutch 1 is designed to detachably contact with a driven unit A. When the centrifugal clutch 1 is continuously rotated, it is able to drive the driven unit A, so as to achieve transmission of power.

To assemble the centrifugal clutch 1 of the present invention, the centrifugal weights 20 are sequentially connected to the base plate 10 by engaging the connecting sections 21 of the centrifugal weights 20 with the locating sections 11 of the base plate 10.

Then, the angular acceleration response assembly 30 is positioned in a space encircled by the centrifugal weights 20, and the returning elements 40 are sequentially connected at two ends 41 separately to the associating sections 22 of the centrifugal weights 20 and the catch sections 31 of the angular acceleration response assembly 30, such that the angular acceleration response assembly 30 is suspended in the base plate 10. Finally, the cover plate 50 is associated with the base plate 10 by engaging the through holes 51 on the cover plate 50 with the locating sections 11 of the base plate 10.

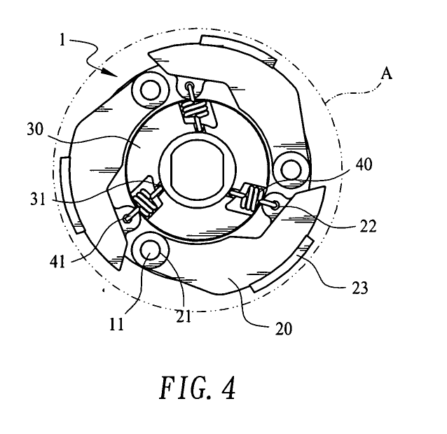

Please refer to FIG. 4 that is a top view showing the centrifugal clutch 1 is in a position before contacting with the driven unit A. When the centrifugal clutch 1 is not rotated, the centrifugal weights 20 are restrained by the returning elements 40 to an initial position.

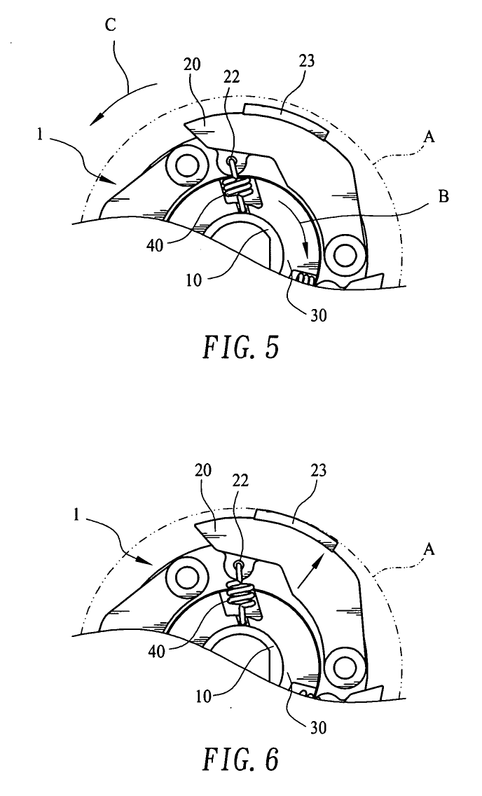

Please refer to FIG. 5. When the centrifugal clutch 1 is driven by an engine, the base plate 10 is rotated in a direction indicated by the arrow C. However, when there is an instantaneously quickly increased acceleration rate to suddenly increase the engine output, the angular acceleration response assembly 30 moves in a reverse direction indicated by the arrow B due to a sudden big change in rotating inertia and tensions the returning elements 40.

At this point, the centrifugal weights 20 require an increased centrifugal force to overcome an instantaneous pull from the returning elements 40. That is, the centrifugal clutch 1 must be rotated at an increased speed for the centrifugal weights 20 to get higher centrifugal force to overcome the returning force of the tensioned returning element and let the centrifugal weights 20 can be centrifugally moved outward, so that the driving faces 23 at the outer surfaces of the centrifugal weights 20 could thrust against the driven unit A, as shown in FIG. 6.

The action of the automatically and continuously adjustable centrifugal clutch 1 of the present invention can be briefly explained as below.

When there is an instantaneously quickly increased acceleration (i.e., the throttle is actuated fully opened suddenly) at starting, an instantaneously increased engine angular acceleration is resulted. At this point, angular acceleration response assembly 30 is subjected to a big change in rotating inertia and moved in a reverse direction to tension the returning element 40 and pull the centrifugal weight 20 more tightly inwardly. At this point, the centrifugal force of the centrifugal weight 20 is not able to overcome the pull force of the more tensioned returning element 40 due to insufficient engine revolving speed, so the rotating speed of the base plate 10 or centrifugal weight 20 must be continuously increased to let the centrifugal weights 20 produce a higher centrifugal force sufficient to overcome the pull force of the more tensioned returning element 40, then the centrifugal weights 20 of the centrifugal clutch 1 can be centrifugally moved outward and bring the driving faces 23 to thrust against the driven unit A, so that a vehicle can be started with a high acceleration rate. On the other hand, when there is a slowly increased acceleration (i.e., the throttle is actuated normally) at starting, the angular acceleration response assembly 30 is subjected to almost no change in rotating inertia, the returning force of returning elements 40 remains same as the designed value. Therefore, the centrifugal weight 20 may engage with the driven unit A at a slow engine revolving speed to move the vehicle normally.

In other words, with the automatically and continuously adjustable centrifugal clutch 1 of the present invention, a driver may, depending on an actual need, actuate the throttle fully opened suddenly to let the centrifugal weight 20 of centrifugal clutch 1 proceed the engagement at high engine revolving speed when it is desired for the vehicle to have a higher initial acceleration; or slowly and normally actuate the throttle to let centrifugal weight 20 of centrifugal clutch 1 proceed the engagement at original low engine revolving speed when it is desired for the vehicle to start smoothly at low fuel consumption.

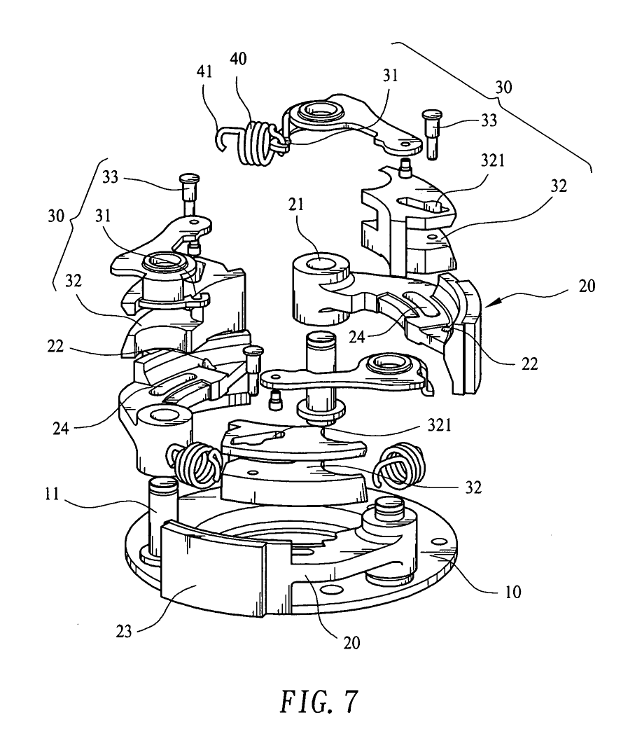

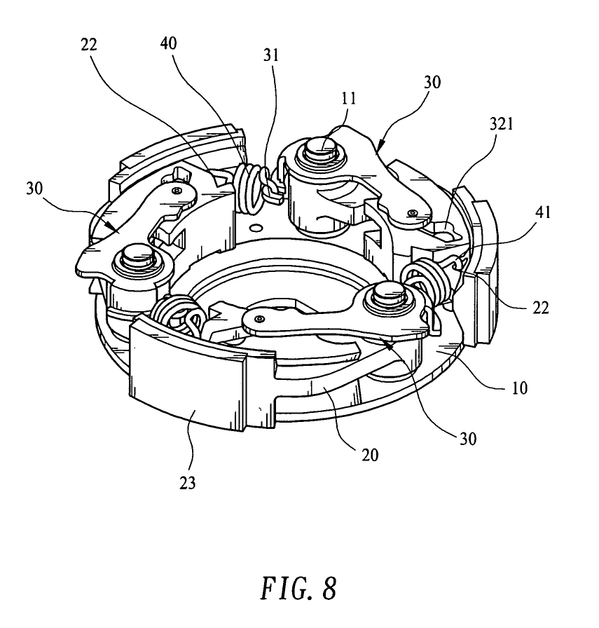

FIGS. 7 and 8 are exploded and assembled perspective views, respectively, showing an automatically and continuously adjustable centrifugal clutch 1 according to a second embodiment of the present invention. As shown, the centrifugal clutch 1 in the second embodiment includes a base plate 10, on which at least one locating section 11 is provided; at least one centrifugal weight 20, which is provided at a first end with a connecting section 21 for engaging with the locating section 11 on the base plate 10, at an inner side of a second end opposite to the first end with an associating section 22, at an outer surface with a driving face 23, and at an inner side with a sliding section 24; at least one angular acceleration response assembly 30 adapted to connect to the centrifugal weight 20 via the sliding section 24, and each being provided with a catch section 31 corresponding to the associating section 22 on the centrifugal weight 20; and at least one returning element 40 having two ends 41 separately connected to the associating section 22 of the centrifugal weight 20 and the catch section 31 of the angular acceleration response assembly 30.

In the illustrated second embodiment of the present invention, there are three locating sections 11, three centrifugal weights 20, three angular acceleration response assembly 30, and three returning elements 40; and the locating section 11 is a pivot shaft, the associating section 22 is an insertion hole, the driving face 23 is a wear pad, and the returning element 40 is a spring.

In the illustrated second embodiment of the present invention, the sliding section 24 is internally provided with a bearing, and has a wear-proof layer (not shown) provided around an inner surface thereof.

In the illustrated second embodiment, the angular acceleration response assembly 30 includes a receiving section 32 to be associated with the centrifugal clutch weight 20 therein. The receiving section 32 is formed with a guiding section 321 extending through the receiving section 32 and corresponding to the sliding section 24 of the centrifugal weight 20, such that an insertion pin 33 may be extended through the receiving section 32 via the guiding section 321 into the sliding section 24. The insertion pin 33 is provided on an outer surface with a wear-proof coating (not shown).

In the illustrated second embodiment of the present invention, the base plate 10 is associated with a cover plate 50, which is provided with at least one through hole 51 corresponding to the at least one locating section 11 of the base plate 10, similar to that shown in FIG. 3.

To assemble the centrifugal clutch 1 in the second embodiment of the present invention, the centrifugal weights 20 are sequentially connected to the base plate 10 by engaging the connecting sections 21 of the centrifugal weights 20 with the locating sections 11 of the base plate 10. Then, the angular acceleration response assemblies 30 are sequentially connected to the centrifugal weights 20 by engaging the receiving sections 32 with the centrifugal weights 20 and inserting the insertion pins 33 through the guide section 321 on the receiving sections 32 into the sliding section 24 on the centrifugal weights 20, such that each of the angular acceleration response assemblies 30 is movable relative to a corresponding centrifugal weight 20 within the sliding section 24. Then, each of the returning elements 40 is connected at an end 41 to the associating section 22 of one centrifugal weight 20 and at the other end 41 to the catch section 31 of a following angular acceleration response assembly 30. Finally, the cover plate 50 is associated with the base plate 10 by engaging the through holes 51 on the cover plate 50 with the locating sections 11 of the base plate 10.

The centrifugal clutch 1 in the second embodiment of the present invention provides the same effect as the first preferred embodiment.

When the throttle is fully opened suddenly at starting, an instantaneously increased engine angular acceleration is resulted. At this point, a high rotation speed is required for the centrifugal weights 20 of the centrifugal clutch 1 to let the centrifugal clutch 1 can be centrifugally moved outward and bring the driving faces 23 to thrust against the driven unit A, so that a vehicle can be started at a higher acceleration rate. On the other hand, when the throttle is actuated slowly at starting, the engine angular acceleration is small and the change in the rotating inertia is also small, and the angular acceleration response assemblies 30 do not tension the returning elements 40. Therefore, the centrifugal weights 20 can be centrifugally moved outward to thrust against the driven unit A at an original low engine revolving speed for the vehicle to start smoothly at low fuel consumption. The following table 1 lists related data obtained from the clutches test of comparing the performance of conventional clutches and the clutch according to the second embodiment of the present invention.

The tested conventional clutches are mounted on a Gy6 125 cc Scooter manufactured by KYMCO. The rider performing the test weighs 70 kgs, and the unit weight of each centrifugal weight 20 of the three the clutches is 220 gm. In the test, five statuses of different throttle openings are used for the testing:
1. The Stall-in status means to actuate the throttle slowly until the clutch proceeding an engagement and the vehicle starts to move.
2. The 1/4, 2/4, 3/4 and 4/4 status of throttle opening; the actuation of each type of throttle degree is done instantaneously.

In Table 1, “Clutch A” is an original [stock] clutch mounted on a Scooter of 125 cc, Model Gy6; “Clutch B” is also an original clutch mounted on a Scooter of 125 cc, Model Gy6, but has a replaced clutch spring with stronger pulling force; and “Clutch C” is a clutch described in the above second embodiments of the present invention.

TABLE 1
Engine Revolving Speed (rpm) at Clutch Engagement

| | Throttle | | | |
|---|---|---|---|---|
| | opening | Clutch A | Clutch B | Clutch C |
| 1 | Stall-in | 3000–3200 | 3900–4100 | 3000–3200 |
| 2 | 1/4 | 3000–3200 | 3900–4100 | 3400–3500 |
| 3 | 2/4 | 3000–3200 | 3900–4100 | 3800–4000 |
| 4 | 3/4 | 3000–3200 | 3900–4100 | 4300–4500 |
| 5 | 4/4 | 3000–3200 | 3900–4100 | 4900–5000 |

In the above Table 1, the engine revolving speed in rpm at clutch engagement is recorded from an engine revolution counter, and the listed data are only average ranges for showing the engine revolving speed at clutch engagement is a fixed value (for conventional clutch) or a variable value (for present invention).

As can be seen from Table 1, the engine revolving speed at clutch engagement for the Clutch A at any throttle openings, including stall-in, 1/4, 2/4, 3/4, and 4/4, is generally the same and falls in the range from 3000 to 3200 rpm.

The Clutch B is an original clutch with a replaced clutch spring having a higher pulling force to enable an increased engine revolving speed at clutch engagement about 1000 rpm higher than the Clutch A. As can be seen from Table 1, the engine revolving speed at clutch engagement for the Clutch B at any throttle openings, including stall-in, 1/4, 2/4, 3/4, and 4/4, is generally the same and falls in the range from 3900 to 4100 rpm.

As to the Clutch C, that is, the automatically and continuously adjustable centrifugal clutch 1 of the present invention (second embodiment), the engine revolving speed at clutch engagement varies at five different throttle openings of stall-in, 1/4, 2/4, 3/4, and 4/4. As can be seen from Table 1, when the throttle is actuated slowly at starting, the engine revolving speed at clutch engagement is an original design value. However, when the throttle is actuated instantaneously at starting, the engine revolving speed at clutch engagement varies with different throttle openings. More specifically, the larger the throttle opening is, the higher the engine revolving speed at clutch engagement is. In other words, the Clutch C, or the automatically and continuously adjustable centrifugal clutch 1 in the second embodiment of the present invention allows different engine revolving speeds at clutch engagement at different throttle openings to realize the objects of the present invention, that is, to smoothly start a vehicle at reduced fuel consumption by slowly actuating the throttle at starting, or to powerfully take-off the vehicle by suddenly and instantaneously actuating the throttle at start, without the need of disassembling a CVT housing and centrifugal clutch to change a clutch spring.

With the centrifugal clutch of the present invention, a rider is allowed to actuate the throttle instantaneously quickly at starting for the vehicle to have high staring torque and good accelerating ability, or to actuate the throttle slowly at starting to achieve smooth riding and normal fuel consumption, depending on actual need. That is, the present invention meets not only the requirement of good engine performance, but also the requirement of economical driving.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An automatically and continuously adjustable centrifugal clutch, comprising:
a base plate used to receive a power source;
at least one centrifugal weight assembled to said base plate;
at least one angular acceleration response assembly connected to said at least one centrifugal weight; and
at least one returning element having two ends separately connected to one said centrifugal weight and one said angular acceleration response assembly;
whereby when said power source is instantaneously quickly actuated and said base plate is brought to instantaneously circularly accelerate, said at least one angular acceleration response assembly is subjected to a sudden big change in rotating inertia and proceed a reverse displacement to tension said at least one returning element and thereby pull said centrifugal weight more tight; and the said base plate is continuously circularly accelerated to let said centrifugal weight produce sufficient centrifugal force and be able to move centrifugally outward to engage with and transmit power to a driven unit, allowing the adjustment of clutch engagement is automatic and continuous.

2. An automatically and continuously adjustable centrifugal clutch, comprising:
a base plate being provided with at least one locating section;
at least one centrifugal weight being provided at a first end with a connecting section for engaging with said locating section of said base plate, at a second end opposite to said first end with an associating section, and at an outer side with a driving face;
at least one angular acceleration response assembly being provided with a catch section corresponding to said associating section of said centrifugal weight; and
at least one returning element having two ends separately connected to said associating section of said at least one centrifugal weight and said catch section of said at least one angular acceleration response assembly.

3. The automatically and continuously adjustable centrifugal clutch as claimed in claim 2, wherein said locating section of said base is a pivot shaft.

4. The automatically and continuously adjustable centrifugal clutch as claimed in claim 2, wherein said associating section of said centrifugal weight is an insertion hole.

5. The automatically and continuously adjustable centrifugal clutch as claimed in claim 2, wherein said driving face of said centrifugal weight is a wear pad.

6. The automatically and continuously adjustable centrifugal clutch as claimed in claim 2, wherein said angular acceleration response assembly is an annular member

7. The automatically and continuously adjustable centrifugal clutch as claimed in claim 2, wherein said returning element is a spring.

8. The automatically and continuously adjustable centrifugal clutch as claimed in claim 2, wherein said angular acceleration response assembly is surrounded by said at least one centrifugal weight.

9. The automatically and continuously adjustable centrifugal clutch as claimed in claim 2, wherein said base plate is associated with a cover plate with said at least one locating section of said base plate engaged with at least one through hole provided on said cover plate corresponding to said locating section.

10. An automatically and continuously adjustable centrifugal clutch, comprises:
a base plate being provided with at least one locating section;
at least one centrifugal weight being provided at a first end with a connecting section for engaging with said locating section of said base plate, at an inner side of a second end opposite to the first end with an associating section, at an outer surface with a driving face, and at an inner side with a sliding section;
at least one angular acceleration response assembly adapted to associate with said at least one centrifugal weight via said sliding section, and being provided with a catch section corresponding to said associating section on said centrifugal weight; and
at least one returning element having two ends separately connected to said associating section of one said centrifugal weight and said catch section of one said angular acceleration response assembly.

11. The automatically and continuously adjustable centrifugal clutch as claimed in claim 10, wherein said locating section of said base plate is a pivot shaft.

12. The automatically and continuously adjustable centrifugal clutch as claimed in claim 10, wherein said associating section of said centrifugal weight is an insertion hole.

13. The automatically and continuously adjustable centrifugal clutch as claimed in claim 10, wherein said driving face of said centrifugal weight is a wear pad.

14. The automatically and continuously adjustable centrifugal clutch as claimed in claim 10, wherein said angular acceleration response assembly includes a receiving section for connecting with the said centrifugal weight therein.

15. The automatically and continuously adjustable centrifugal clutch as claimed in claim 14, wherein said receiving section is formed with a guide section extending through said receiving section and corresponding to said sliding section of said centrifugal weight, such that an insertion pin may be extended through said receiving section via said guide section into said sliding section.

16. The automatically and continuously adjustable centrifugal clutch as claimed in claim 10, wherein said returning element is a spring.

17. The automatically and continuously adjustable centrifugal clutch as claimed in claim 10, wherein said base plate is associated with a cover plate with said at least one locating section of said base engaged with at least one through hole provided on said cover plate corresponding to said locating section.

18. The automatically and continuously adjustable centrifugal clutch as claimed in claim 10, wherein said sliding section is internally provided with a bearing.

19. The automatically and continuously adjustable centrifugal clutch as claimed in claim 10, wherein said sliding section has a wear-proof layer provided around an inner surface thereof.

20. The automatically and continuously adjustable centrifugal clutch as claimed in claim 15, wherein said insertion pin is provided on an outer surface with a wear-proof coating.
